(19) United States
(12) Patent Application Publication
(10) Pub. No.: US 2004/0120459 A1
(43) Pub. Date: Jun. 24, 2004

(54) Industrial machine vision system having a direct conversion X-ray detector

(76) Inventors: John P. Crowley, Fort Collins, CO (US); Nasreen Chopra, Belmont, CA (US); S. Jeffrey Rosner, Palo Alto, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/323,312

(22) Filed: Dec. 18, 2002

(51) Int. Cl. H05G 1/64

(52) U.S. Cl. 378/98.6

(57) ABSTRACT

A method and apparatus for inspecting structural features of selected portions of an electronic device using a direct conversion X-ray detector. An manufactured device under inspection is positioned under an irradiating beam of X-rays. Those X-rays that are transmitted through the device are collected by a direct conversion detector, which converts the collected X-rays directly into electrical signals in an X-ray conversion layer. The electrical signals have an intensity that is non-uniformly proportional to the intensity of the transmitted X-rays such that the electrical signals represent the radiographic density of at least portions of the electronic device under inspection. A signal analysis system then converts the electrical signals into numerical information that is representative of specific features of the device under inspection.

### FIELD OF THE INVENTION

This invention relates generally to automated inspection systems and techniques. More particularly, this invention relates to the use of direct conversion detectors in high speed X-ray inspection systems.

### BACKGROUND OF THE INVENTION

Existing automated inspection systems for electronic devices and assemblies make use of penetrating radiation, such as X-rays, to form images that exhibit features representative of the internal structure of the devices and connections. The images or pictures formed represent the X-ray shadow cast by an object being inspected when it is illuminated by a beam of X-rays. The shadow is detected and recorded by a scintillator containing a material that is sensitive to X-rays, such as praseodymium-doped gadolinium oxysulfide. The shadow recorded on the scintillator is then viewed by a highly sensitive camera and magnified to form an image that is either viewed by a human operator or digitized and analyzed by a computer. Conventional tomographic techniques such as laminography are currently used for inspection of electrical connections such as solder joints. These systems exhibit image resolution on the order of several micrometers, for example 20 micrometers (0.0008 inches) or greater, and are capable of generating multiple images per second in an industrial production line. However, as production volume increases and manufacturing costs are driven downward, these inspection systems need to become faster and have higher resolution. There is a time lag in the formation of the shadow image on the scintillator, due to the decay lifetime of the fluorescence phenomena in virtually all the materials available for such application. Additionally, the secondary process of converting the x-ray photons to visible light photons and then capturing these visible photons with conventional image capture devices results in substantial signal loss, typically greater than 90% even in well-designed systems. This occurs as a result of the isotropic production of these secondary visible photons, the large number that escape the wave guiding within the scintillator material, and the finite collection angle of the camera optics. This isotropic production of photons also causes the image size of the x-ray absorption event to increase, severely limiting the resolution of such systems. Even though industrial X-ray inspection systems are workhorses in today's inspection environments, the decay lifetime of the fluorescence, signal loss and physical limitations on increasing the brightness of the x-ray sources conspire to limit the speed at which suitable images can be captured. Additionally, the resolution limits of the sensor require greater magnification to be used to meet system requirements, additionally limiting the throughput. These problems are substantially addressed by this invention.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a schematic view of the system configuration in accordance with embodiments of the invention.

FIG. 2 is a schematic view of a flat panel detector in accordance with embodiments of the invention.

### SUMMARY OF THE INVENTION

The present invention is an X-ray machine vision system for inspecting electronic devices, including a mechanical device, an electrical component, or a mechanical component of an electronic device, using a direct conversion X-ray detector assembly, hereafter referred to as a direct conversion detector, and a method for performing inspections of electronic devices using such a direct conversion detector.

In summary, the present invention is a method and apparatus for inspecting structural features of selected portions of any manufactured device, such as an electronic device using a direct conversion detector. The device under inspection is positioned under an irradiating beam of X-rays. Those X-rays that are transmitted through the device under inspection are collected by a direct conversion detector and the detector converts the collected X-rays directly to a charge in an X-ray conversion layer. This charge signal is proportional to the deposited x-ray energy, which is a complex function of the energy distribution of the photons and the absorbance, or stopping power of the X-ray conversion layer. These electrical signals then represent the radiographic density of at least portions of the device under inspection. A signal analysis system converts the electrical signals into numerical information that is representative of specific features of the device under inspection.

### DETAILED DESCRIPTION OF THE INVENTION

The term electronic device, as used herein, is intended to include a broad variety of items such as printed circuit boards, printed wiring boards, printed wiring assemblies (printed circuit boards having components soldered thereto), multichip modules, discrete components such as ball grid arrays, fine pitch leaded integrated circuit packages, chip scale packages, etc.

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

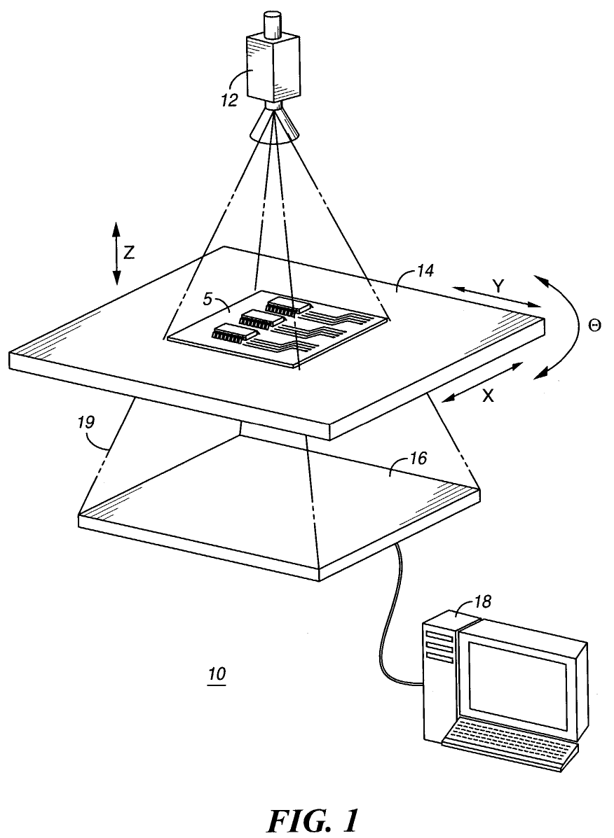

In one embodiment of our invention, an automated real-time inspection system uses digital X-ray radiographic imaging techniques and a rule-based defect recognition system. Referring to FIG. 1, a schematic view of the major component layout, the automated X-ray inspection system 10 includes an X-ray source 12, a multi-axis positioning system 14, a direct conversion X-ray detector 16, and signal analysis system 18. An optional control system (not shown) comprises a digital computer that has computer peripherals associated therewith. Computer peripherals include, but are not limited to, data storage system, printer, display monitor, keyboard, interfaces to the multi-axis positioning system 14 and safety system, interfaces to an data processing/defect recognition system and interfaces to control the X-ray source.

The X-ray source 12 generates a beam of X-rays, which may be collimated to improve inspection quality, that irradiate the device under inspection. The device under inspection is placed at a location where it can be irradiated by the X-ray beam. Typically, this is an X-Y positioning table, but numerous positioning devices can be utilized by one of ordinary skill in the art. Several examples will now be illustrated, and are not meant to limit the scope of our invention. 1) A translational table is used to move, for example, multichip modules (MCMs) or chip scale packages (CSPs) into the path of the X-ray beam to impinge upon a single large stationary direct conversion detector. 2) A large array of direct conversion detectors and an addressable x-ray source can be used to effectively take tiled images without motion of either the detector or the device under inspection. 3) A very small direct conversion detector and fixed X-ray source could be used with an elaborate six axis stage to assemble arbitrary views of an arbitrary object. 4) A multi-axis positioning system includes an x-y positioning table that permits movement of the electronic device mounted therein in a plane. The X-Y positioning table includes a rotation table that permits 360 degree rotation (in the theta axis). The rotation table and X-Y positioning table may be generically defined as a motion table that is mounted upon a tilt beam which permits tilting of the motion table in an angled plane to the horizontal plane. A Z movement system permits movement of the motion table assembly in a vertical direction. For purposes of clarity in FIG. 1, the tilt beam and X, Y and Z movement systems are not shown in structural form and may be implemented in many forms by one skilled in the art. The motion table may be moved through a horizontal plane in an x-y direction along with being rotated, tilted, or moved in a vertical direction toward or away from the X-ray source. An optional motion controller receives the control signals from the control system computer to provide the automatic electromechanical movement within the multi-axis positioning system.

When the electronic device 5 under inspection is irradiated by the X-ray beam 12, one portion of the X-ray beam is absorbed by portions of the device under inspection. Yet other portions 19 of the X-ray beam are transmitted through the device under inspection where it impacts upon and is collected by a direct conversion detector 16 that is positioned in-line with the X-ray beam 12. A direct conversion X-ray detector is a specific type of detector that consists of two parts: an x-ray conversion material in the form of a film or layer and an electronics circuit for converting this to a usable signal. The X-ray signals absorbed in the X-ray conversion film are converted to an electrical charge signal with an intensity that is related to the incident intensity at the absorbed position. The electrical charge signal is pulled down onto electrodes immediately below the conversion layer by an internal electric field and is temporarily stored. This is in contrast to conventional scintillator detectors that are used in prior art systems where X-rays impacting upon a fluorescent or scintillating screen are converted into a visible light image, which is then captured by a video camera.

The signal analysis system 18 is a data processing system that receives the electrical charge signal generated by the direct conversion detector 16 and converts it into numerical information that represents specific features of the electronic device under test. Unlike prior art scintillator-based systems that create an intermediate image of the impinging X-rays on a scintillator that fluoresces to create visible light photons which are transferred to a video camera or other detector to form a visual image, a visual image is not created in our system. Instead, the individual electronic signals generated by the impingement of the incident X-rays 19 onto the conversion layer of the direct conversion detector 16 create a charge map which is analyzed by the signal analysis system 18 to create a digital representation that is a numerical electronic equivalent to the physical features of the electronic device under test. Optionally, this digital representation can be compared to numerical data that is resident in a historical library stored within the signal analysis system. While not required, the digital representation can be transferred to a video screen, if desired, to aid a human observer in interpreting the inspection results.

Direct conversion X-ray detectors can exist in many formats, but have several basic features. They consist of a material, usually but not necessarily a semiconductor such as CdTe, CdZnTe, HgI₂, PbI₂, Si, Ge, that absorbs the incoming x-ray photon and converts the energy into a number of free electrons that is proportional to the energy of the photon. This collection material is patterned into an array of pixels, typically with a patterned metalization but alternately by having discrete elements for each pixel, with provision for electrically connecting each pixel to an electronic circuit, typically provided in some monolithic fashion in a large array matched electrically and physically to the conversion material array. An electric field applied to this conversion material extracts these electrons into a charge collection device in the circuit, typically a capacitor, for storage in anticipation of subsequent analysis. The circuit can be a CMOS readout circuit or a flat panel array, consisting of thin-film transistors on a glass or other substrate. The analysis can consist of collecting the charge from many photons and then periodically converting this to a number for digital representation. Alternately, the charge from a single photon can be likewise analyzed upon collection, determining the energy of each photon arriving at each pixel and assembling an energy distribution histogram of incoming x-ray photons. This latter approach has substantial value for industrial inspection as the energy distribution of the arriving photons can be compared with the distribution of the unabsorbed source to determine more specifically the nature of the object being imaged. The x-ray conversion material can be a single slab of single crystal, or bulk semiconductor, sawn from a boule and polished that is affixed to the electronic circuit with solder bumps or other types of electronic connectors. It can alternatively be a film of amorphous or polycrystalline semiconductor, or other detective material that is directly deposited onto an electronic circuit, making contact directly without the need for external connections. One skilled in the art of hybrid electronics assembly can easily understand the large variety of assembly techniques that can be used.

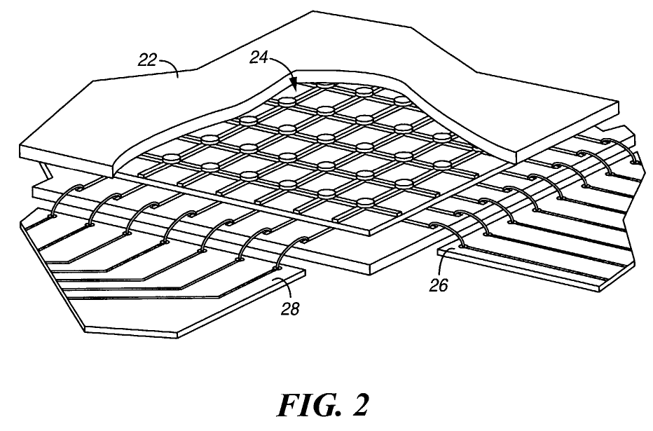

FIG. 2 shows a schematic diagram of the direct-conversion FPD construction. X-ray signals absorbed in the X-ray conversion film 22 are converted to an electrical charge signal with an intensity proportional to the incident intensity at the absorbed position. The electrical charge signal is pulled down onto the electrodes 24 immediately below by an internal electric field and is stored by the storage capacity of the TFT matrix. The TFT operates as switches to read the stored electrical charge signals. The signals comprising the two-dimensional “image” are read by sequentially switching ON each row 26 and column 28 of the TFT matrix. An example of an even larger flat panel x-ray detector has a plurality of detector tiles disposed adjacent one another, each of the detector tiles carrying an array of pixel elements, and a continuous x-ray sensitive layer formed across the detector tiles, the radiation detecting layer generating electrical charge in response to incident x-ray radiation, and each of the pixel elements sensing the electrical charge to thereby form an electrical signal indicative of x-ray radiation intensity at a location substantially coincident with the respective pixel element.

Other variations will occur to those skilled in the art upon consideration of these teachings. For example, one can employ a large area array or matrix of direct conversion detectors in a stationary pattern and suitably address them individually as the x-ray beam rotates. Additionally, one can employ both stationary detectors and a stationary X-ray beam, and interpret the data with a suitable computer. Additionally, one can take advantage of the very high imaging speed and sensitivity made uniquely available by the direct conversion sensor to capture many geometric views of an object and use these to calculate three-dimensional information that provides additional information about the object.

In summary, and without intending to limit the scope of the invention, operation of an industrial machine vision system according to a method consistent with certain embodiments of the invention can be carried out by the use of a direct conversion X-ray detector. In the illustrations above, the detector has been shown in a simple two dimensional use, and in a more sophisticated three dimensional tomographic system. However, this should not be limiting since other variations will occur to those skilled in the art upon consideration of the teachings herein.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. An industrial machine vision system for inspecting structural features of selected portions of a manufactured device, comprising:
an X-ray source for providing a beam of X-rays;
a positioning system for relatively positioning the device under inspection within the beam of X-rays;
at least one direct conversion detector for collecting those X-rays from the beam that are transmitted through the electronic device, the direct conversion detector directly converting the collected X-rays into electrical signals in an X-ray conversion layer; and
a signal analysis system for converting the electrical signals into numerical information representative of the device under inspection.

2. The apparatus of claim 1, further comprising a computational system to analyze the numerical information and compute a three-dimensional description in accordance with a predetermined set of instructions.

3. The apparatus of claim 1, wherein the signal analysis system further comprises comparing the numerical information to a library.

4. The apparatus of claim 1, wherein the positioning system comprises a motion table responsive to a controller for moving the electronic device mounted thereupon in at least one translational axis.

5. The apparatus of claim 1, wherein the electrical signals represent the radiographic density of at least portions of the electronic device under inspection.

6. The apparatus of claim 1, wherein the device under inspection is an electronics device or an assembly of a plurality of electronics devices.

7. The apparatus of claim 1, wherein the direct conversion detector comprises a semiconductor mated to an electronic circuit.

8. The apparatus of claim 7, wherein the semiconductor is a sawn and polished bulk semiconductor or a deposited thin film semiconductor.

9. The apparatus of claim 7, wherein the electronics circuit is an MOS integrated circuit or a thin-film transistor based flat panel circuit.

10. An industrial machine vision system for inspecting structural characteristics of selected portions of an electronic device comprising:
a stationary X-ray beam situated to irradiate the electronic device;
a plurality of stationary direct conversion x-ray detectors arranged in a pattern for collecting those X-rays that are transmitted through the electronic device and for converting the transmitted x-rays into electrical signals; and
a digital signal processing system for converting the electrical signals into numerical information to form a two dimensional representation of a slice through a three dimensional object or a three dimensional description of the electronic device.

11. The apparatus of claim 10, further comprising a computational system to analyze the numerical information in accordance with a predetermined set of instructions for specific features of the electronic device.

12. The apparatus of claim 10 wherein the direct conversion detector comprises an X-ray conversion layer for converting the X-rays absorbed in the layer to an electrical charge signal having an intensity that is related to the intensity of the transmitted X-rays.

13. A method of inspecting structural features of selected portions of an electronic device, comprising the steps of:
supporting the electronic device by a multi-axis positioning means adjustable for optimum exposure of the electronic device to a source beam of X-rays;
exposing the device being inspected to a beam of X-rays having sufficient energy to penetrate the device; and
detecting, by means of at least one direct conversion X-ray detector, X-rays transmitted through the electronic device, to form an electronic coded signal representative of the detected X-rays.

14. The method of claim 13, further comprising the steps of:
analyzing the electronic coded signal in accordance with a predetermined set of instructions so as to measure specific features of the electronic device and comparing the analyzed signal to a library.

15. The method of claim 13, wherein the direct conversion detector comprises an X-ray conversion layer for converting the X-rays absorbed in the layer to an electrical charge signal having an intensity that is related to the intensity of the transmitted X-rays.

16. The method of claim 13, wherein the direct conversion detector comprises a semiconductor mated to an electronic circuit.

17. The method of claim 16, wherein the semiconductor is a sawn and polished bulk semiconductor or a deposited thin film semiconductor.

18. The method of claim 16, wherein the electronics circuit is an MOS integrated circuit or a thin-film transistor based flat panel circuit.

19. The method of claim 13, wherein the electronic coded signal represents the radiographic density of at least portions of the electronic device.
